(19) United States
(12) Patent Application Publication
(10) Pub. No.: US 2018/0339539 A1
(43) Pub. Date: Nov. 29, 2018

(54) PRINTED MATERIAL, INFORMATION PROCESSING APPARATUS, AND PLOT DIAGRAM CREATION METHOD

(71) Applicant: SUMITOMO RUBBER INDUSTRIES, LTD., Kobe-shi (JP)

(72) Inventor: Tatsuya YASHIKI, Kobe-shi (JP)

(73) Assignee: SUMITOMO RUBBER INDUSTRIES, LTD., Kobe-shi (JP)

(21) Appl. No.: 16/052,035

(22) Filed: Aug. 1, 2018

Related U.S. Application Data
(62) Division of application No. 15/061,366, filed on Mar. 4, 2016.

(30) Foreign Application Priority Data
Mar. 6, 2015 (JP) 2015-045016

(51) Int. Cl. B42D 15/00; B42D 25/405; G06F 17/50

(52) U.S. Cl. CPC B42D 15/004; G06F 17/50; B42D 25/405

(57) ABSTRACT

A method of creating a plot diagram having plotted thereon a plurality of points, the plurality of points respectively corresponding to a plurality of shafts for a golf club, includes defining a plot region having a first axis of a first index; deriving values of the first index for the shafts; and plotting points, in the plot region, corresponding to the shafts at positions corresponding to the values of the first index. The first index represents a characteristic value of a shaft and is a value that is derived using stiffness values in a plurality of positions of the shaft along a longitudinal direction of the shaft. The method further includes printing a plurality of sub-regions on the plot region in such a mode that the plurality of sub-regions are distinguishable from each other by a user, the plurality of sub-regions respectively corresponding to different types of golfer. At least one point of the plurality of points is positioned inside of one of the plurality of sub-regions and at least another one point of the plurality of points is positioned inside of another of plurality of the sub-regions.

### CROSS REFERENCE TO RELATED APPLICATIONS

This application is a Divisional of U.S. application Ser. No. 15/061,366, which was filed on Mar. 4, 2016, and which claims priority to Japanese Patent Application No. 2015-45016 filed on Mar. 6, 2015. An entirety of each of the above-identified applications is hereby incorporated by reference.

### FIELD OF INVENTION

The present invention relates to a printed material on which a plot diagram of characteristic values of shafts for a golf club is printed, an information processing apparatus and program that display the plot diagram on a display or cause a printer to print the plot diagram, and a method of creating the plot diagram.

### BACKGROUND

An understanding of the characteristics of shafts for a golf club is often necessary, such as in the case of so-called fitting for selecting golf clubs suited to a golfer. Important indices representing the characteristics of shafts include flex and torque, with flex being an index representing how stiff the shaft is (bending stiffness), and torque being an index representing how easily the shaft twists (torsional stiffness).

Flex and torque are indices by which the stiffness of the entire shaft is evaluated. Accordingly, while an understanding of flex and torque enables the stiffness of the entire shaft to be understood, knowing the positions along the shaft at which stiffness is high or low can be important in better understanding the characteristics of shafts. One such index is called flex point (kick point). Flex point is an index representing the point where the shaft readily flexes (where stiffness is low), and the types of flex points include low flex point, high flex point and mid flex point. Low flex point means that the stiffness on the tip side (head side) of the shaft is relatively low, high flex point means that the stiffness on the butt side (grip side) is low, and mid flex point means that the stiffness near the middle is relatively low.

There is also an index called the International Flex Code (IFC) that is described in Patent Literature 1 (see JP 2014-121412A). The IFC is a code that represents the stiffness values of the shaft at four places in a direction along the shaft, with each value being represented using a single-digit numerical value such as 0 to 9, and these four numerical values being arrayed in the direction along the shaft.

### SUMMARY of INVENTION

Information on the above flex points and IFCs is generally calculated by the manufacturer, and provided to users in a mode such as being published in a catalog. However, given the multitude of different shafts that are available, users cannot readily comprehend the differences between shafts simply by being provided information on flex points and IFCs as textual information.

An object of the present invention is to enable a user to intuitively understand differences in shaft characteristics relating to the distribution of shaft stiffness values between a plurality of types of shafts.

A printed material according to a first aspect of the present invention is a printed material on which is printed a plot diagram having plotted thereon a plurality of points respectively representing characteristic values of a plurality of shafts for a golf club. This plot diagram includes a plot region having an axis that represents a first index. The first index is determined based on a distribution of stiffness values of the shaft in a direction along the shaft. Note that the printed material referred to here is typically a paper medium such as a catalog, a flier, a poster or a magazine, but is not particularly limited as long as the plot diagram can be printed, and may be a medium other than paper, such as a wooden board or a metal plate.

A printed material according to a second aspect of the present invention is the printed material according to the first aspect, in which the first index is determined based on the distribution of stiffness values of the shaft in at least three places in the direction along the shaft.

A printed material according to a third aspect of the present invention is the printed material according to the second aspect, in which the distribution of stiffness values of the shaft is a code in which are arrayed numerical values respectively corresponding to the stiffness values of the shaft in at least three places in the direction along the shaft.

A printed material according to a fourth aspect of the present invention is the printed material according to any of the first aspect to the third aspect, in which the first index represents a flex point, a distribution shape of bending stiffness, or a distribution shape of torsional stiffness.

A printed material according to a fifth aspect of the present invention is the printed material according to any of the first aspect to the fourth aspect, in which the first index is represented numerically.

A printed material according to a sixth aspect of the present invention is the printed material according to any of the first aspect to the fifth aspect, in which the plot region further has an axis that represents a second index different from the first index and representing an attribute of the shaft.

A printed material according to a seventh aspect of the present invention is the printed material according to any of the first aspect to the fifth aspect, in which a form of the points plotted in the plot region represents a second index different from the first index and representing an attribute of the shaft.

A printed material according to an eighth aspect of the present invention is the printed material according to the sixth aspect or the seventh aspect, in which the second index is determined based on the distribution of stiffness values of the shaft in the direction along the shaft or represents a torque, a flex or a weight of the shaft.

A printed material according to a ninth aspect of the present invention is the printed material according to the seventh aspect, in which the second index represents a manufacturer or a brand of the shaft.

A printed material according to a tenth aspect of the present invention is the printed material according to any of the sixth aspect to the ninth aspect, in which the plot region further has an axis that represents a third index different from the first index and the second index and representing an attribute of the shaft.

A printed material according to an eleventh aspect of the present invention is the printed material according to the tenth aspect, in which the third index is determined based on the distribution of stiffness values of the shaft in the direction along the shaft or represents a torque, a flex or a weight of the shaft.

A printed material according to a twelfth aspect of the present invention is the printed material according to any of the first aspect to the eleventh aspect, in which a region corresponding to a shaft suitable for a certain type of golfer is printed in the plot region in a mode distinguishable from other regions by a user.

An information processing apparatus according to a thirteenth aspect of the present invention is provided with a control unit configured to display on a display or cause a printer to print a plot diagram having plotted thereon a plurality of points respectively representing characteristic values of a plurality of shafts for a golf club.

The plot diagram includes a plot region having an axis that represents a first index. The first index is determined based on a distribution of stiffness values of the shaft in a direction along the shaft.

A non-transitory computer readable medium storing a program according to a fourteenth aspect of the present invention is a non-transitory computer readable medium storing a program for causing a computer to execute the step of displaying on a display or causing a printer to print a plot diagram having plotted thereon a plurality of points respectively representing characteristic values of a plurality of shafts for a golf club. The plot diagram includes a plot region having an axis that represents a first index. The first index is determined based on a distribution of stiffness values of the shaft in a direction along the shaft.

A plot diagram creation method according to a fifteenth aspect of the present invention is a method of creating a plot diagram having plotted thereon a plurality of points respectively representing characteristic values of a plurality of shafts for a golf club, with the method including the following steps. Also, a first index referred to below is determined based on a distribution of stiffness values of the shaft in a direction along the shaft.

(1) A step of defining a plot region having a first axis of a first index.
(2) A step of deriving values of the first index for the shafts.
(3) A step of plotting points, in the plot region, corresponding to the shafts at positions corresponding to the values of the first index.

The present invention enables characteristic values of a plurality of shafts for a golf club to be presented to a user in the form of a plot diagram. The characteristic values that are plotted here include an index (first index) that is determined based on the distribution of stiffness values of the shaft in the direction along the shaft. Accordingly, the user is able to intuitively understand differences in shaft characteristics relating to the distribution of shaft stiffness values between a plurality of types of shafts.

### BRIEF DESCRIPTION OF DRAWINGS

FIG. 1 is a plot diagram according to a first embodiment.

FIG. 2 is a diagram illustrating the International Flex Code.

FIG. 3 is a diagram illustrating an example of a method of measuring the value of bending stiffness.

FIG. 4 is a diagram showing the distribution of bending stiffness for various types of shafts.

FIG. 5 is a block diagram showing the configurations of an information processing apparatus, a display, and a printer.

FIG. 6 is a plot diagram according to a second embodiment.

FIG. 7 is another plot diagram according to the second embodiment.

### DETAILED DESCRIPTION OF THE PREFERRED EMBODIMENTS

Hereinafter, some embodiments of a printed material on which a plot diagram of characteristic values of shafts for a golf club is printed according to the present invention will be described, with reference to the drawings. Also, embodiments of an information processing apparatus and program that display the plot diagram on a display or cause a printer to print the plot diagram and a method of creating the plot diagram will also be described.

### 1. First Embodiment

### 1-1. Overall Outline

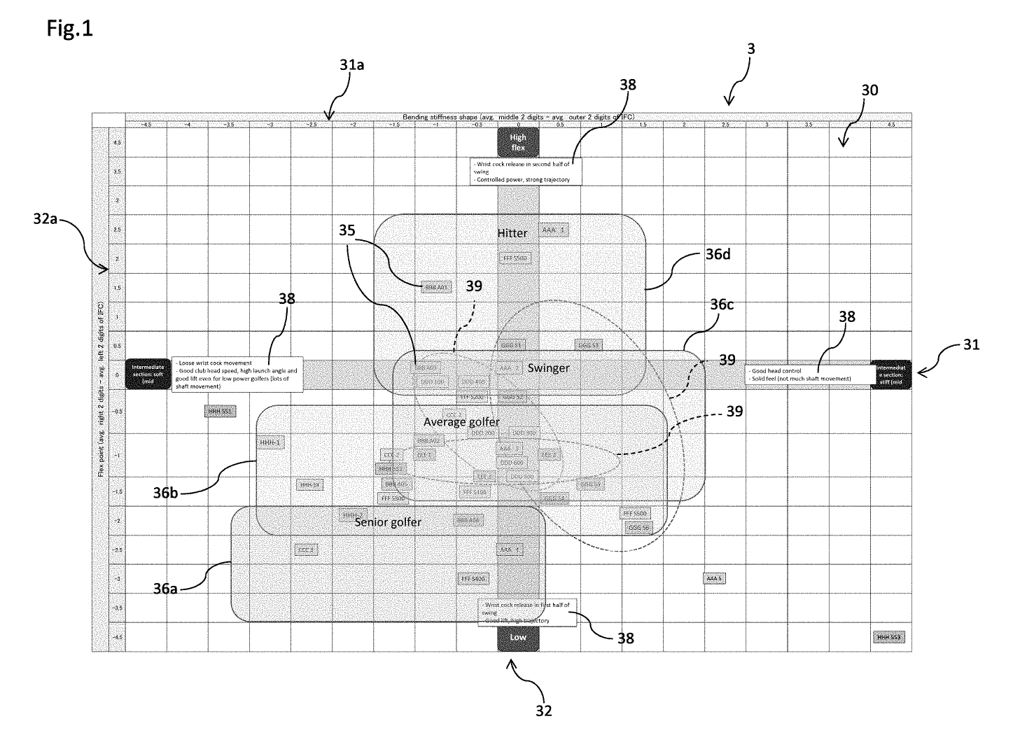

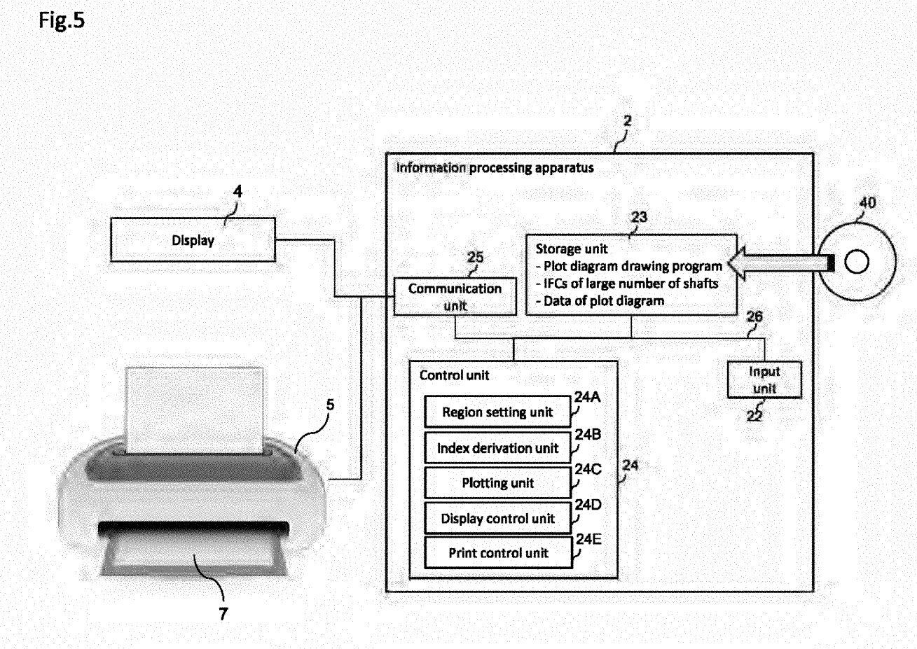

FIG. 1 shows a plot diagram 3 according to the first embodiment. This plot diagram 3 is a shaft characteristics map representing the characteristics of a large number of shafts for a golf club in a visually intelligible manner, with points 35 corresponding to the large number of shafts being plotted in a predetermined plot region 30 based on the respective characteristics of the shafts. The plot diagram 3 is typically printed on printing paper 7 or displayed on a display 4 (see FIG. 5). A user looking at the plot diagram 3 output in such modes is able to readily compare the characteristics of these shafts, and intuitively understand differences in shaft characteristics between the shafts.

The plot region 30 of the plot diagram 3 is a two-dimensional region having two axes 31 and 32 that are orthogonal to each other. These axes 31 and 32 are both axes representing indices that represent shaft characteristics. In the present embodiment, the horizontal axis 31 is an axis of an index representing the distribution shape of bending stiffness (hereinafter, EI shape), and the vertical axis 32 is an axis of an index representing flex points (kick points). Note that the shafts that are targeted in the present embodiment are carbon shafts.

The EI shape index and the flex point index are both indices that are determined based on the distribution of stiffness values of the shaft in the direction along the shaft. Also, these indices are both quantitatively represented using numerical values, and, in the present embodiment, are computed using the International Flex Code (IFC). For this reason, the IFC will be described first.

### 1-2. International Flex Code (IFC)

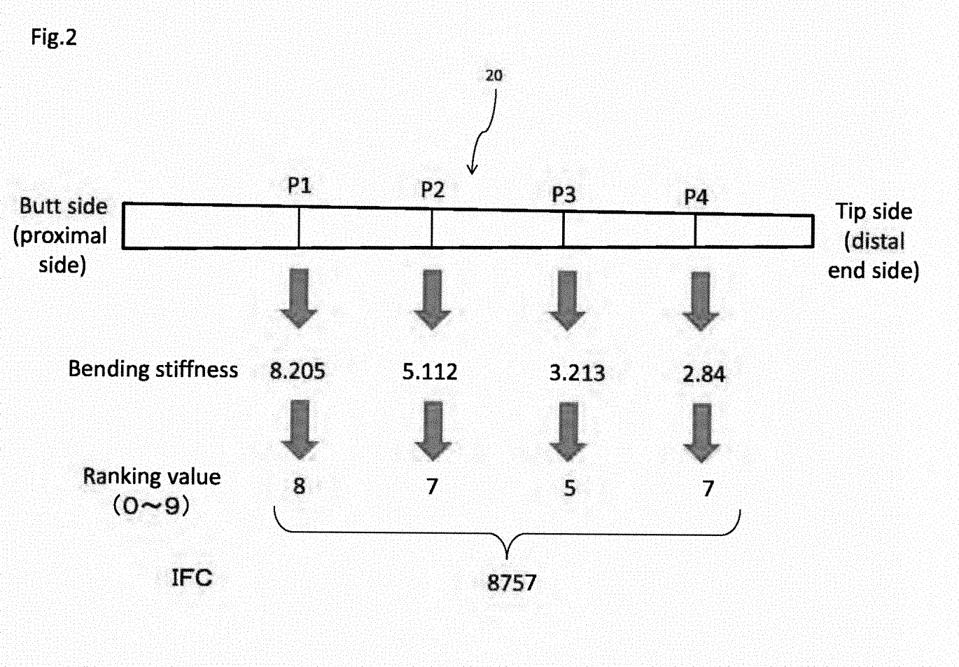

The IFC is, as shown in FIG. 2, a code representing the bending stiffness values of a shaft 20 at four places P1 to P4 in the direction along the shaft 20, with each bending stiffness value being represented by using a single-digit numerical value such as 0 to 9, and these four numerical values being arrayed in the direction along the shaft 20. Accordingly, the IFC serves as a code representing the distribution of the values of bending stiffness of the shaft 20 in the direction along the shaft 20.

Specifically, first, as shown in FIG. 2, the four measurement points P1 to P4 for measuring bending stiffness are defined at roughly regular intervals in the direction along the shaft 20. For example, places that are respectively 36 inches, 26 inches, 16 inches and 6 inches from the tip end of the shaft 20 can be taken as the measurement points P1, P2, P3 and P4. The bending stiffness at these four measurement points P1 to P4 is then measured and evaluated with a numeric value.

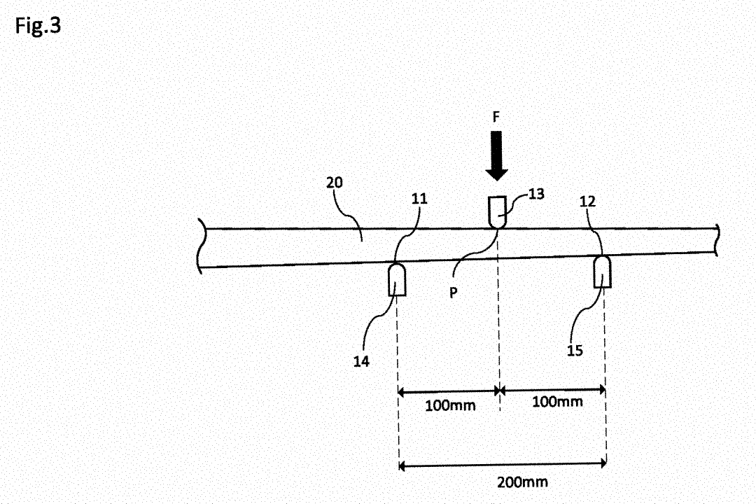

The bending stiffness (EI value: N·m²) at each measurement point P (P1 to P4) of the shaft can be measured by various methods, and can, for example, be measured as shown in FIG. 3 using a model 2020 measuring machine manufactured by Intesco Co., Ltd. (maximum load: 500 kgf). This measurement method involves measuring a bending amount a when a load F is applied to a measurement point P from above while supporting the shaft 20 from below at two support points 11 and 12. The distance (span) between the support point 11 and the support point 12 can, for example, be set to 200 mm, and the measurement point P can be set as an intermediate point between the support point 11 and the support point 12. More specifically, an indenter 13 is moved downward at a fixed speed (e.g., 5 mm/min.) at the measurement point P, in a state where supporting bodies 14 and 15 supporting the support points 11 and 12 are fixed. The movement of the indenter 13 is stopped at the point at which the load F reaches 20 kgf, the bending amount a (mm) of the shaft 20 at this moment is measured, and this bending amount a is converted into a bending stiffness (N·m²).

Next, the bending stiffness at the above four measurement points P1 to P4 is respectively converted into a 10-level ranking value. Specifically, the ranking value can be calculated from the bending stiffness (EI value), in accordance with the following conversion tables (tables 1 to 4) for measurement points P1 to P4 (in tables 1 to 4, the converted ranking values are shown in the IFC column). The four ranking values thus assigned to the measurement points P1 to P4 are arrayed such that values corresponding more to the butt side are positioned more to the left, and values corresponding more to the tip side are positioned more to the right. The 4-digit code thus obtained is the IFC. With the IFC, the stiffness at each position increases as the numerical value of the corresponding digit increases.

TABLE 1
(a) IFC: 36 inches from tip

| | EI value [×9.8 N · m²] |
|---|---|
| IFC | Max.~Min. |
| 9 | ~8.295 |
| 8 | 8.295~7.86 |
| 7 | 7.86~7.425 |
| 6 | 7.425~6.99 |
| 5 | 6.99~6.555 |
| 4 | 6.555~6.12 |
| 3 | 6.12~5.685 |
| 2 | 5.685~5.25 |
| 1 | 5.25~4.185 |
| 0 | 4.185~0 |

TABLE 2
(b) IFC: 26 inches from tip

| | EI value [×9.8 N · m²] |
|---|---|
| IFC | Max.~Min. |
| 9 | ~5.543 |
| 8 | 5.543~5.306 |
| 7 | 5.306~5.069 |
| 6 | 5.069~4.832 |
| 5 | 4.832~4.595 |
| 4 | 4.595~4.358 |
| 3 | 4.358~4.121 |
| 2 | 4.121~3.884 |
| 1 | 3.884~3.647 |
| 0 | 3.647~0 |

TABLE 3
(c) IFC: 16 inches from tip

| | EI value [×9.8 N · m²] |
|---|---|
| IFC | Max.~Min. |
| 9 | ~3.849 |
| 8 | 3.849~3.658 |
| 7 | 3.658~3.467 |
| 6 | 3.467~3.276 |
| 5 | 3.276~3.085 |
| 4 | 3.085~2.894 |
| 3 | 2.894~2.703 |
| 2 | 2.703~2.512 |
| 1 | 2.512~2.321 |
| 0 | 2.321~0 |

TABLE 4
(d) IFC: 6 inches from tip

| | EI value [×9.8 N · m²] |
|---|---|
| IFC | Max.~Min. |
| 9 | ~2.94 |
| 8 | 2.94~2.86 |
| 7 | 2.86~2.78 |
| 6 | 2.78~2.7 |
| 5 | 2.7~2.62 |
| 4 | 2.62~2.54 |
| 3 | 2.54~2.46 |
| 2 | 2.46~2.38 |
| 1 | 2.38~2.3 |
| 0 | 2.3~0 |

### 1-3. Details of Plot Diagram

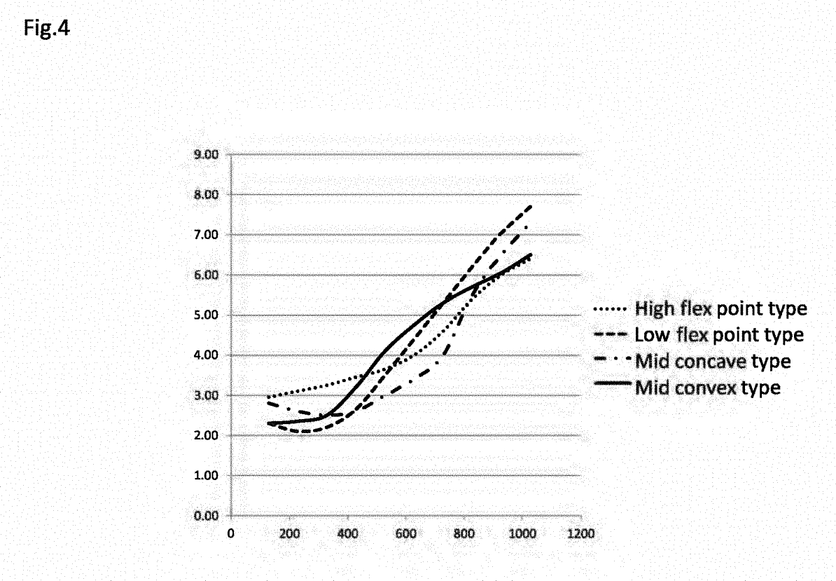

Next, the plot diagram 3 will be described in detail. As already mentioned, the horizontal axis 31 of the plot diagram 3 represents the EI shape that is calculated from the IFC. This index quantitatively represents whether a section having a relatively high bending stiffness is near the middle, or on the butt side, the tip side, or near both of these ends in the direction along the shaft, with a larger value indicating a more mid convex type shaft and a smaller value indicating a more mid concave type shaft. Note that mid convex and mid concave referred to here represent the shape of a graph whose horizontal axis represents positions in the direction along the shaft and whose vertical axis represents EI values of bending stiffness (see FIG. 4), with mid convex type indicating a type of shaft with relatively high bending stiffness near the middle, and mid concave type indicating a type of shaft with relatively low bending stiffness near the middle. FIG. 4 is a graph in which distances (mm) from the distal end of the shaft are shown on the horizontal axis and EI values of bending stiffness are shown on the vertical axis, with distribution maps of the bending stiffness (EI values) of the above-mentioned mid convex type and mid concave type shafts and below-mentioned low flex point type and high flex point type shafts shown as references.

Specifically, the index relating to EI shape according to the present embodiment is calculated as a value obtained by subtracting the average value of the two outer numerical values from the average value of the two middle numerical values of the four numerical values constituting the IFC. Accordingly, if the IFC is “8757”, for example, the index value will be (7+5)/2−(8+7)/2=−1.5, indicating a slightly mid concave type shaft. Also, if the IFC is “3566”, the index value will be 1, indicating a slightly mid convex type shaft.

On the other hand, the vertical axis 32 of the plot diagram 3 represents the flex point (kick point) that is calculated from the IFC, as already mentioned. This index quantitatively represents whether a section having a relatively high bending stiffness is on the butt side or on the tip side in the direction along the shaft, with a larger value indicating a more high flex point type shaft and a smaller value indicating a more low flex point type shaft. Note that high flex point means that the stiffness on the butt side is relatively low, and low flex point means that the stiffness on the tip side is relatively low.

Specifically, the index relating to the flex point according to the present embodiment is calculated as a value obtained by subtracting the average value of the two left-hand numerical values from the average value of the two right-hand numerical values of the four numerical values constituting the IFC. Accordingly, if the IFC is “8757”, for example, the index value will be (5+7)/2−(8+7)/2=−1.5, indicating a slightly low flex point type shaft. Also, if the IFC is “3566”, the index value will be 2, indicating a high flex point type shaft.

In the plot region 30 that is defined by two axes such as described above, a large number of points 35 respectively corresponding to a large number of shafts are depicted. Accordingly, the user is able to readily compare a large number of shafts based on the characteristics of those shafts while looking at the plot diagram 3. Also, the points 35 are depicted as regions having a certain area, and information specifying the type of shaft, such as the name of the manufacturer and the product ID, for example, are written in or near these regions. Accordingly, the user is able to readily comprehend which shafts have what characteristics.

Also, as described above, the two indices relating to the EI shape and the flex point according to the present embodiment are represented numerically. Accordingly, a user looking at the plot diagram 3 can quantitatively and intuitively grasp the characteristics of the shafts. This is a more persuasive way of explaining the characteristics of shafts than merely indicating the characteristics with textual information such as “low flex point” or “high flex point”. Also, scales 31a and 32a of the indices are marked on the plot region 30 in order to enhance such effects.

Also, the form of the points 35 represents attributes of the shafts. More specifically, colors that differ according to the manufacturer of the shaft are used for the points 35. Accordingly, it also becomes easier for a user looking at the plot diagram 3 to identify the particular features of each manufacturer. Also, enclosure lines 39 enclosing the points 35 corresponding to shafts of the same manufacturer are also provided in order to enhance such effects. Note that the points 35 can also be configured differently such as with different shapes including circles and squares or with different patterns, instead of or in addition to being colored differently according to the attributes of the shafts. The form of the points 35 can also be changed by brand rather than being changed by manufacturer.

Also, in the plot region 30, regions 36a to 36d showing the characteristics of golfers are depicted. The region 36a is a region corresponding to shafts suitable for seniors, and the region 36b is a region corresponding to shafts suitable for average golfers. Also, the region 36c is a region corresponding to shafts suitable for swingers, and the region 36d is a region corresponding to shafts suitable for hitters. These regions 36a to 36d are depicted in a mode that distinguishes them from other regions in the plot region 30. Conceivable ways for distinguishing these regions include color differentiation, use of different patterns, or setting boundaries. Also, text or the like describing what these regions are (in the example of FIG. 1, “senior”, “average golfer”, “swinger” “hitter” are used) is preferably included.

Also, comments 38 indicating the characteristics (shaft characteristics, ball trajectory characteristics, etc.) in the case where the values of the EI shape and the flex point are large and small are provided in the plot region 30. These comments 38 describe the swing tendencies in the case of using shafts having larger or smaller values of these indices. The user is thereby able to more easily recognize the significance of the axes.

### 1-4. Information Processing Apparatus

Next, an information processing apparatus 2 that draws the above plot diagram 3 will be described, with reference to FIG. 5. The information processing apparatus 2 is manufactured by installing a drawing program stored on a computer-readable recording medium 40 such as a CD-ROM or a USB memory in a general-purpose computer from the recording medium 40. The drawing program is software for drawing the above-mentioned plot diagram 3 based on the IFCs of a large number of shafts, displaying the plot diagram 3 on the display 4 and printing the plot diagram 3 via the printer 5, and causes the information processing apparatus 2 to execute operations which will be discussed later. The display 4 can be constituted by a liquid crystal display or the like. Note that the display 4 may be separate from the information processing apparatus 2 or may be incorporated into the apparatus main body, such as a notebook PC, a tablet or a smartphone.

The information processing apparatus 2 is provided with an input unit 22, a storage unit 23, a control unit 24, and a communication unit 25. These units 22 to 25 are connected via a bus line 26, and can communicate with each other. The input unit 22 can be constituted by a mouse, a keyboard, a touch panel or the like, and accepts operations from a user with respect to the information processing apparatus 2. The communication unit 25 is a communication interface that enables communication between the information processing apparatus 2 and an external device, and transmits data of the plot diagram 3 to the display 4 and the printer 5.

The storage unit 23 is constituted by a non-volatile memory storage device such as a hard disk. The storage unit 23 stores information on the IFCs of a large number of shafts, in addition to storing the drawing program. The data of the plot diagram 3 drawn by the drawing program is also stored.

The control unit 24 is constituted by a CPU, a ROM, a RAM, and the like. The control unit 24 operates in a virtual manner as a region setting unit 24A, an index derivation unit 24B, a plotting unit 24C, a display control unit 24D, and a print control unit 24E, by reading out and executing the drawing program stored in the storage unit 23. The region setting unit 24A draws the plot region 30 having the axes 31 and 32, and draws the scales 31a and 32a on this region 30. The region setting unit 24A also draws the above-mentioned regions 36a to 36d and comments 38 at appropriate positions. The index derivation unit 24B calculates the values of the EI shape and the flex point for each shaft, based on the information on the IFCs in the storage unit 23. The plot unit 24C performs drawing so as to plot the point 35 corresponding to each shaft at a corresponding position in the plot region 30, based on the values of the indices derived by the index derivation unit 24B. The plot unit 24C also draws the above-mentioned enclosure lines 39 at appropriate positions. The display control unit 24D converts the data of the plot diagram 3 thus drawn into image data for display, transmits this image data to the display 4 via the communication unit 25, and displays the plot diagram 3 on the display 4. Similarly, the printing control unit 24E converts the data of the plot diagram 3 into image data for printing, and then transmits this image data to the printer 5 via the communication unit 25, and prints the plot diagram 3 on the printing paper 7.

As described above, the plot diagram 3 can be efficiently created using the information processing apparatus 2, but can also be created manually. If an image of the manually created plot diagram 3 is read with a scanner and stored in the storage unit 23 of the information processing apparatus 2, this plot diagram 3 can be output via the display 4 and the printer 5 by the display control unit 24D and the printing control unit 24E.

### 2. Second Embodiment

Next, a plot diagram 103 according to a second embodiment will be described. This plot diagram 103 is obtained by extending the two-dimensional plot diagram 3 according to the first embodiment to three dimensions. Hereinafter, for simplicity, the plot diagram 103 will be described focusing on the differences with the plot diagram 3. The method of creating the plot diagram 103 and the configuration of the information processing apparatus that implements this method are similar to the first embodiment, and thus will not be described.

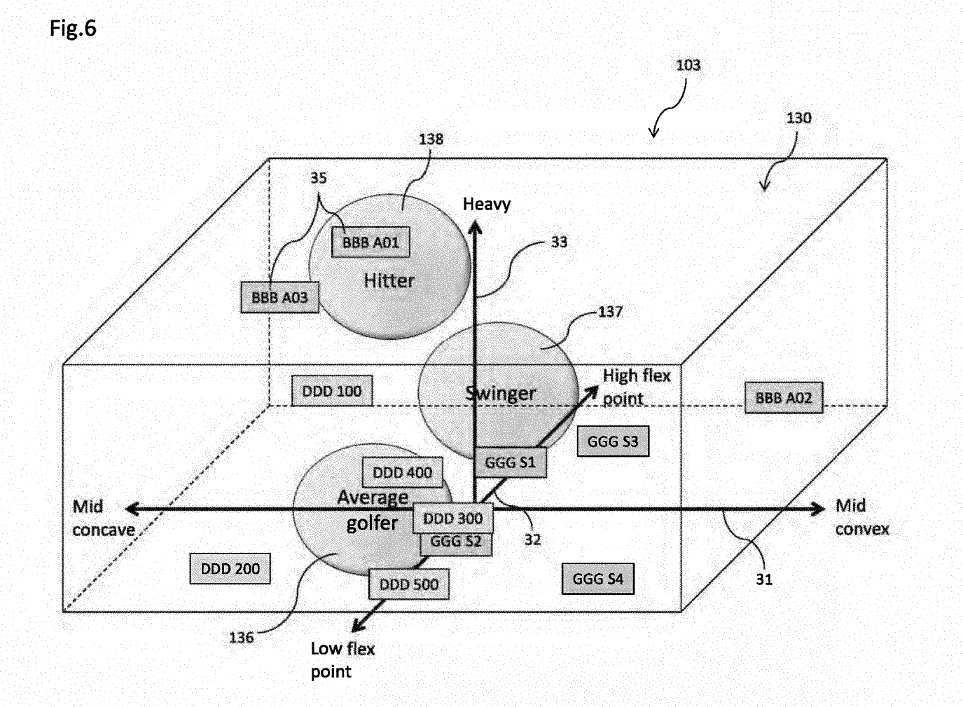

As shown in FIG. 6, a plot region 130 of the plot diagram 103 according to the present embodiment is a three-dimensional space having two axes 31 and 32 representing the indices relating to the EI shape and the flex point similarly to the first embodiment, and additionally having a third axis 33 representing the weight of the shaft. Note that since this three-dimensional plot region 130 is represented in a planar manner as it would be output on the display 4 or the printing paper 7, the axes 31 to 33 are not orthogonal in the plot diagram 103. However, these axes 31 to 33 intersect in a mode that makes it easy for someone looking at the plot diagram 103 to imagine that these axes 31 to 33 are orthogonal to each other.

In the plot region 130 that is thus defined by three axes, a large number of points 35 respectively corresponding to a large number of shafts are depicted, similarly to the first embodiment. In the plot diagram 103, a large number of shafts can be readily compared, with the weight of the shafts also being taken into consideration. The weight of the shafts is also represented numerically, similarly to the other two indices. Accordingly, a user looking at the plot diagram 103 is able to quantitatively and intuitively grasp the weight of the shafts.

Also, the form of the points 35 similarly represents the attributes of the shaft in the present embodiment. That is, the points 35 are represented in a form that differs according to the brand or manufacturer of the shaft. Note that although not particularly shown in FIG. 6, enclosure lines 39 enclosing the points 35 corresponding to shafts of the same manufacturer can also be provided.

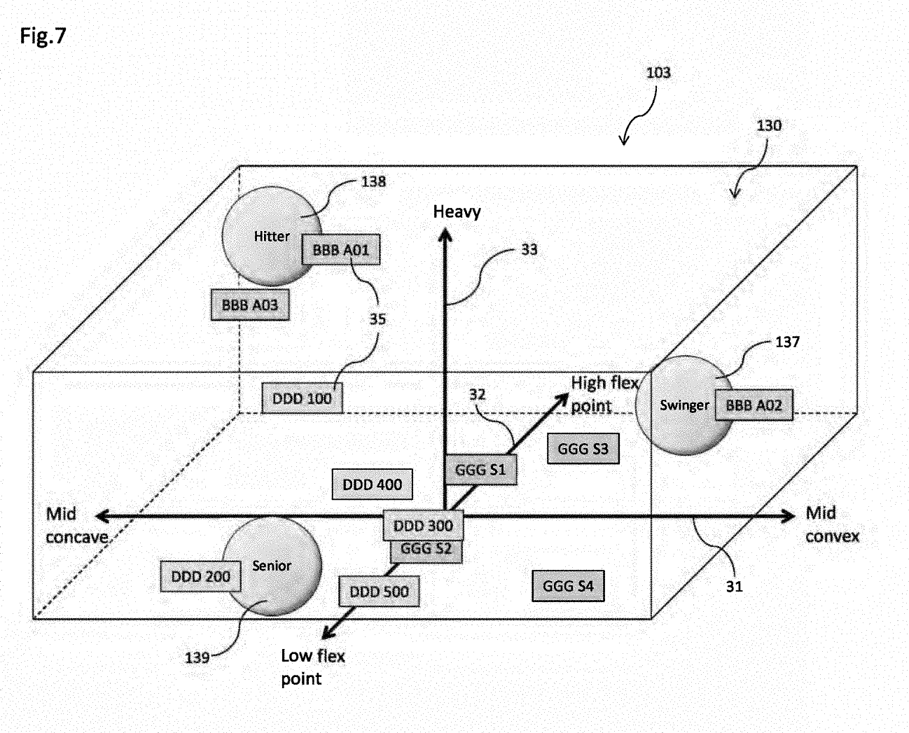

Also, marks 136 to 138 representing regions showing the characteristics of golfers are depicted in the plot region 130. The region in or near the mark 136 is a region corresponding to shafts suitable for average golfers, similarly to the region 36b, and the region in or near the mark 137 is a region corresponding to shafts suitable for swingers, similarly to the region 36c. The region in or near the mark 138 is a region corresponding to shafts suitable for hitters, similarly to the region 36d. As shown in FIG. 7, a region 139 corresponding to shafts suitable for seniors can also be displayed. These marks 136 to 139 enable the user to distinguish the regions in or near the marks 136 to 139 from other regions in the plot region 30. Various methods can be employed to distinguish these regions, similarly to the first embodiment. Also, text describing what these regions are is similarly provided. Furthermore, although not particularly shown in FIGS. 6 and 7, comments 38 indicating the meaning of the indices corresponding to the axes can be similarly provided. In the present embodiment, shaft weight can also be evaluated, thus enabling the characteristics of golfers to be classified in even greater detail.

### 3. Variations

Although embodiments of the present invention have been described above, the present invention is not limited to these embodiments, and various modifications can be made without departing from the spirit of the invention. For example, the following modifications can be made. Also, the features of the following modifications can be combined as appropriate.

3-1 The indices that are represented by the axes 31 to 33 of the plot diagrams 3 and 103 are not limited to those described above, and the index that is represented by at least one of the axes 31 to 33 can be changed to a different index. For example, in the step of deriving the EI shape and the flex point described in the above embodiments, the distribution shape (GJ shape) of torsional stiffness (GJ) and the flex point may be calculated by changing the values of bending stiffness (EI) to the values of torsional stiffness (GJ), and the resultant index may be set as at least one of the indices that are represented by the axes 31 to 33.

Also, the index that is represented by at least one of the axes 31 to 33 may be set as an index representing the torsional stiffness of the entire shaft, the bending stiffness of the entire shaft, or the weight of the shaft.

Also, the indices relating to the flex point and the EI shape can be derived with another suitable mode, rather from the IFC. For example, the stiffness values of three places or five or more places can be measured in the direction along the shaft, a three-digit code or a code of five digits or more can be created, and the values of the flex point and the EI shape can be calculated based on the created code. The same applies to the GJ shape.

Also, the indices that are represented by the axes 31 to 33 do not necessarily need to be indices that are represented numerically, and can be set as indices that take several levels of values other than numerical values represented with text such as “low flex point”, “mid flex point”, “high flex point” or the like, for example.

3-2 In the above embodiments, the points 35 are in a form that shows the manufacturer or the brand, but the form of the points 35 can instead be configured to represent the various indices such as described in the above embodiments and the variation 3-1. For example, a configuration can be adopted in which the color of the points 35 darkens as the value of the index increases.
3-3 The plot diagrams 3 and 103 are respectively two-dimensional and three-dimensional plot diagrams, but can be one-dimensional plot diagrams whose one axis represents one index such as described in the above embodiments and the variation 3-1.

### REFERENCE SIGNS LIST

2 Information processing apparatus (computer)

20 Shaft

24 Control unit

3, 103 Plot diagram

30, 130 Plot region

4 Display

5 Printer

7 Printing paper (printed material)

1. A method of creating a plot diagram having plotted thereon a plurality of points, the plurality of points respectively corresponding to a plurality of shafts for a golf club, the method comprising the steps of:
defining a plot region having a first axis of a first index;
deriving values of the first index for the shafts; and
plotting points, in the plot region, corresponding to the shafts at positions corresponding to the values of the first index,
wherein the first index represents a characteristic value of a shaft and is a value that is derived using stiffness values in a plurality of positions of the shaft along a longitudinal direction of the shaft,
wherein said method further comprises the step of printing a plurality of sub-regions on the plot region in such a mode that the plurality of sub-regions are distinguishable from each other by a user, the plurality of sub-regions respectively corresponding to different types of golfer, and
wherein at least one point of the plurality of points is positioned inside of one of the plurality of sub-regions and at least another one point of the plurality of points is positioned inside of another of plurality of the sub-regions.

2. The method of creating a plot diagram according to claim 1, wherein the first index is derived using stiffness values of the shaft in at least three places along the longitudinal direction of the shaft.

3. The method of creating a plot diagram according to claim 2, wherein the stiffness values of the shaft is a code in which are arrayed numerical values respectively corresponding to the stiffness values of the shaft in at least three places in the direction along the shaft.

4. The method of creating a plot diagram according to claim 1, wherein the first index represents a flex point, a distribution shape of bending stiffness, or a distribution shape of torsional stiffness.

5. The method of creating a plot diagram according to claim 1, wherein the first index is represented numerically.

6. The method of creating a plot diagram according to claim 1, wherein the plot region further has an axis that represents a second index different from the first index and representing an attribute of the shaft.

7. The method of creating a plot diagram according to claim 2, wherein the plot region further has an axis that represents a second index different from the first index and representing an attribute of the shaft.

8. The method of creating a plot diagram according to claim 3, wherein the plot region further has an axis that represents a second index different from the first index and representing an attribute of the shaft.

9. The method of creating a plot diagram according to claim 4, wherein the plot region further has an axis that represents a second index different from the first index and representing an attribute of the shaft.

10. The method of creating a plot diagram according to claim 1, wherein a form of the points plotted in the plot region represents a second index different from the first index and representing an attribute of the shaft.

11. The method of creating a plot diagram according to claim 6, wherein the second index is derived using stiffness values of the shaft in a plurality of positions along the longitudinal direction of the shaft, or represents a torque, a flex or a weight of the shaft.

12. The method of creating a plot diagram according to claim 7, wherein the second index is derived using stiffness values of the shaft in a plurality of positions along the longitudinal direction of the shaft, or represents a torque, a flex or a weight of the shaft.

13. The method of creating a plot diagram according to claim 8, wherein the second index is derived using stiffness values of the shaft in a plurality of positions along the longitudinal direction of the shaft, or represents a torque, a flex or a weight of the shaft.

14. The method of creating a plot diagram according to claim 9, wherein the second index is derived using stiffness values of the shaft in a plurality of positions along the longitudinal direction of the shaft, or represents a torque, a flex or a weight of the shaft.

15. The method of creating a plot diagram according to claim 10, wherein the second index represents a manufacturer or a brand of the shaft.

16. The method of creating a plot diagram according to claim 6, wherein the plot region further has an axis that represents a third index different from the first index and the second index and representing an attribute of the shaft.

17. The method of creating a plot diagram according to claim 16, wherein the third index is determined based on the distribution of stiffness values of the shaft in the direction along the shaft or represents a torque, a flex or a weight of the shaft.

18. The method of creating a plot diagram according to claim 1,
wherein a region corresponding to a shaft suitable for a certain type of golfer is printed in the plot region in a mode distinguishable from other regions by a user.
